(19) United States
(12) Patent Application Publication
(10) Pub. No.: US 2015/0203045 A1
(43) Pub. Date: Jul. 23, 2015

(54) STORAGE BIN HAVING INTEGRATED REFLECTIVE TRIANGLES

(71) Applicant: GM GLOBAL TECHNOLOGY OPERATIONS LLC, Detroit, MI (US)

(72) Inventor: Alejandro Hernandez Covarrubias, Edo Mex (MX)

(73) Assignee: GM GLOBAL TECHNOLOGY OPERATIONS LLC, Detroit, MI (US)

(21) Appl. No.: 14/157,844

(22) Filed: Jan. 17, 2014

(51) Int. Cl. B60R 7/02; B60Q 7/00

(52) U.S. Cl. CPC B60R 7/02; B60Q 7/005

(57) ABSTRACT

A storage bin for a vehicle includes a bottom wall, and a support wall extending vertically upward from the bottom wall. A reflective triangle is coupled to the support wall. The reflective triangle is moveable between a stored position adjacent the support wall, and a deployed position extending vertically upward from the support wall. The storage bin supports the reflective triangle, and positions the reflective triangle in an upright vertical position, a distance above the bottom wall, when the reflective triangle is disposed in the deployed position. The storage bin is removable from a vehicle to remotely position the reflective triangle relative to the vehicle.

### TECHNICAL FIELD

The invention generally relates to a cargo system for a vehicle, and more specifically to a storage bin.

### BACKGROUND

Vehicles may include reflective triangles as supplemental roadside assistance equipment. In the event the vehicle is disabled on the side of a road, the reflective triangles may be positioned to alert oncoming traffic to the disabled vehicle. Some vehicles also come equipped with integrated cargo systems. The cargo systems may include a removable storage bin or tote, which may be stored in a cargo area of the vehicle, such as in a trunk or in a rear hatch area.

### SUMMARY

A storage bin for a vehicle is provided. The storage bin includes a bottom wall, and a support wall extending vertically upward from the bottom wall. A reflective triangle is coupled to the support wall. The reflective triangle is moveable between a stored position adjacent the support wall, and a deployed position extending vertically upward from the support wall. The storage bin supports the reflective triangle, and positions the reflective triangle in an upright vertical position, a distance above the bottom wall, when the reflective triangle is disposed in the deployed position.

A cargo system for a vehicle is also provided. The cargo system includes a storage bin. The storage bin includes a first half and a second half detachably coupled to each other. Each of the first half and the second half of the storage bin includes a bottom wall and a support wall, which extends vertically upward from the bottom wall. A first reflective triangle is coupled to the support wall of the first half of the storage bin. A second reflective triangle is coupled to the support wall of the second half of the storage bin. Each of the first reflective triangle and the second reflective triangle is moveable between a stored position adjacent their respective support wall, and a deployed position extending vertically upward from their respective support wall. A coupling device connects the first half and the second half of the storage bin together. The coupling device is removable to release the first half from the second half, to allow the first reflective triangle and the second reflective triangle to be positioned remotely from each other.

Accordingly, the storage bin may be removed from the vehicle, and positioned remotely from the vehicle. The reflective triangle may then be moved into the deployed position to alert oncoming traffic of a disabled vehicle. The storage bin operates as the base for the reflective triangle, thereby supporting the reflective triangle. Because the reflective triangle is attached to a top edge of the support wall, the reflective triangle is positioned above a ground surface, thereby improving visibility of the reflective triangle. Because the reflective triangle is attached to the storage bin, and stored in the stored position with the storage bin, the reflective triangle is less likely to be inadvertently removed from the vehicle and/or lost. Accordingly, so long as the storage bin is disposed in the vehicle, the reflective triangle is available and accessible.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic exploded perspective view of a storage system for a vehicle.

FIG. 2 is a schematic exploded perspective view of the storage system showing a first reflective triangle in a deployed position, and a second reflective triangle in a stored position.

FIG. 3 is a schematic side view of the storage system showing the first reflective triangle in the stored position, and the second reflective triangle in the deployed position, with a partially cutaway cross section.

FIG. 4 is a schematic exploded perspective view of the storage system.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims. Furthermore, the invention may be described herein in terms of functional and/or logical block components and/or various processing steps. It should be realized that such block components may be comprised of any number of hardware, software, and/or firmware components configured to perform the specified functions.

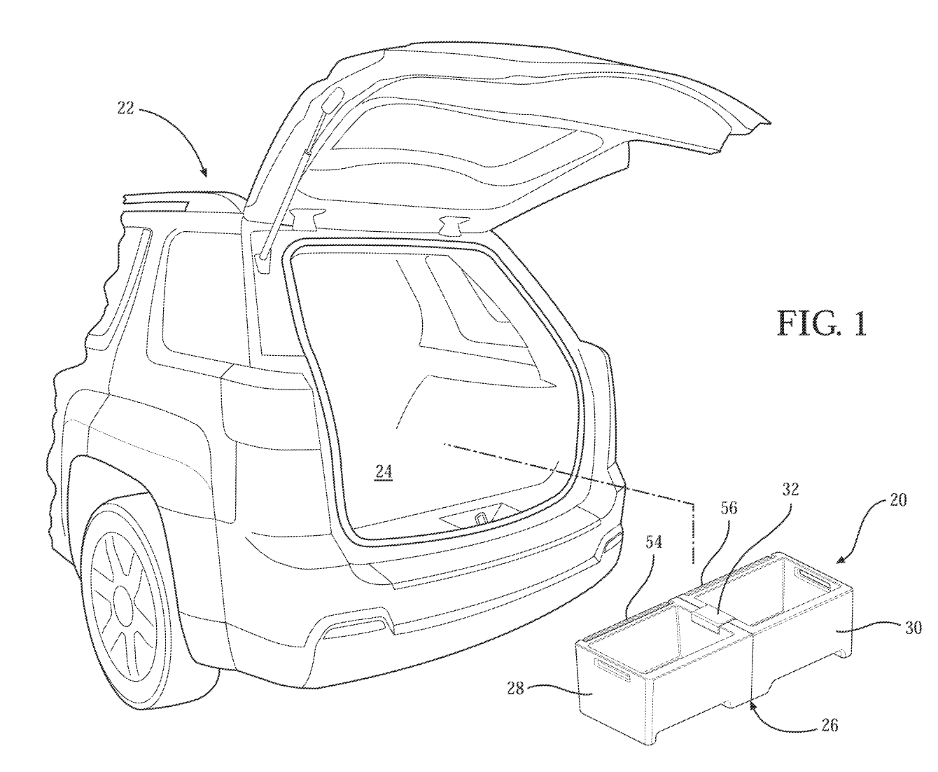

Referring to the Figures, wherein like numerals indicate like parts throughout the several views, a cargo system is generally shown at 20. The cargo system 20 is for a vehicle 22, and may be placed in a trunk or hatch area 24 of the vehicle 22. For example, referring to FIG. 1, the vehicle 22 is shown having a hatch area 24, with the cargo system 20 configured to fit within the hatch area 24 of the vehicle 22. The cargo system 20 may be used for storing objects, and to prevent objects from rolling loosely about the hatch area 24 of the vehicle 22.

The cargo system 20 includes a storage bin 26. As shown, the storage bin 26 includes a first half 28 and a second half 30. The first half 28 and the second half 30 of the storage bin 26 are detachably coupled to each other. A coupling device 32 connects the first half 28 and the second half 30 of the storage bin 26 together. The coupling device 32 is removable to release the first half 28 from the second half 30. As shown, the coupling device 32 is formed as a substantially C-shaped clip, that slides over adjoining vertical edges of the first half 28 and the second half 30 of the storage bin 26. However, it should be appreciated that the coupling device 32 may be configured in some other manner, not shown or described herein.

The storage bin 26, including both the first half 28 and the second half 30 may be manufactured from any suitable material, such as but not limited to a metal material or a plastic material. Preferably, the first half 28 and the second half 30 of the storage bin 26 are manufactured from Expanded Polypropylene (EPP). The storage bin 26, including the first half 28 and the second half 30 thereof, may be sized and/or shaped in any suitable manner to fit within the designated space of each specific vehicle 22.

Each of the first half 28 and the second half 30 of the storage bin 26 includes a bottom wall 34. As shown, each of the first half 28 and the second half 30 of the storage bin 26 includes a first wall 36, a second wall 38, a third wall 40, and a fourth wall 42, joined to define a rectangular box, with the bottom wall 34 disposed at a lower edge of the first wall 36, the second wall 38, the third wall 40, and the fourth wall 42. It should be appreciated that each of the first half 28 and the second half 30 of the storage bin 26, may be used to store various items therein. Additionally, as described in detail below, each of the first half 28 and the second half 30 may operate as a support for a reflective triangle 54, 56 respectively. The first wall 36, the second wall 38, the third wall 40, and the fourth wall 42 each extend vertically upward from the bottom wall 34, to a distal edge 44. The first wall 36 is disposed opposite the third wall 40, and the second wall 38 is disposed opposite the fourth wall 42.

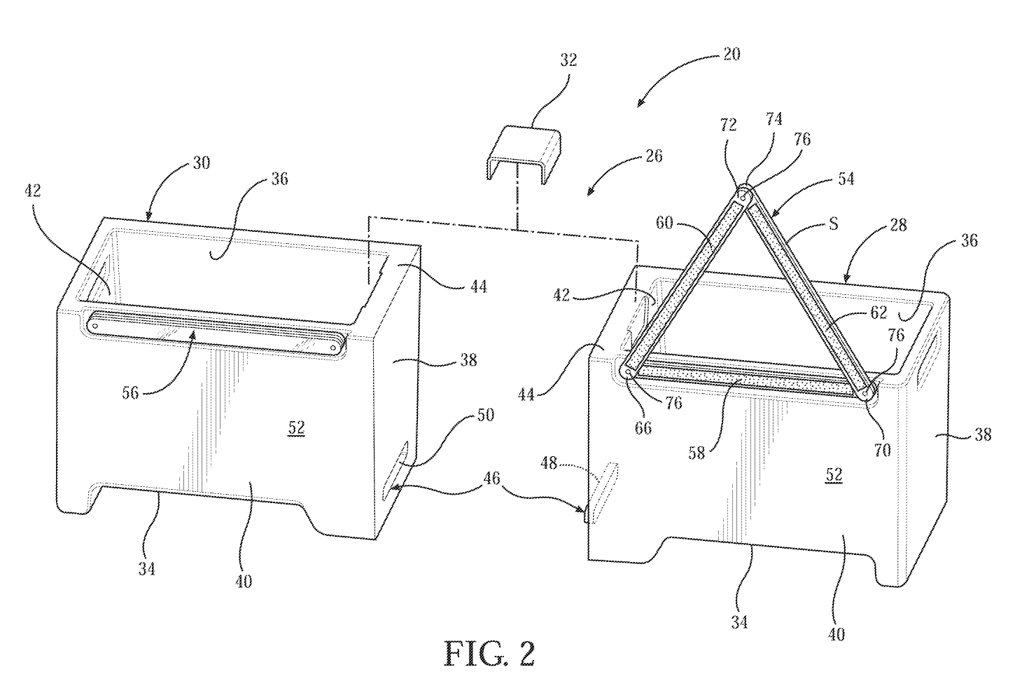

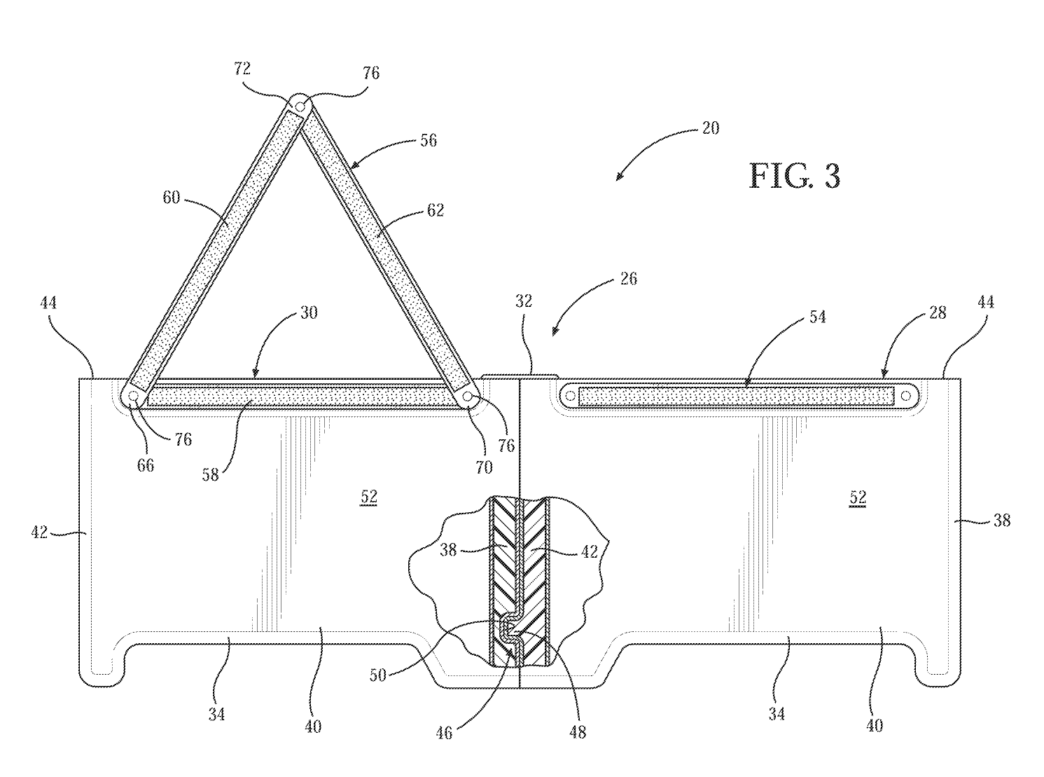

The first half 28 and the second half 30 of the storage bin 26 each include interlocking retention features 46. The interlocking retention features 46 position the first half 28 and the second half 30 of the storage bin 26 relative to each other. The interlocking retention features 46 may be configured in any suitable manner. For example, and as shown in FIGS. 2 and 3, one of the first half 28 and the second half 30 of the storage bin 26 includes a tongue 48 molded into an end wall thereof, and the other of the first half 28 and the second half 30 of the storage bin 26 defines a groove 50 molded into an end wall thereof. As shown, the tongue 48 is molded into the fourth wall 42 of the first half 28 of the storage bin 26, and the groove 50 is molded into the second wall 38 of the second half 30 of the storage bin 26. The groove 50 receives the tongue 48 therein, in interlocking engagement, when positioned adjacent each other, i.e., when the fourth wall 42 of the first half 28 is positioned adjacent the second wall 38 of the second half 30. It should be appreciated that the interlocking retention features 46 may be configured in some other manner, such as a plurality of projections that fit within a plurality of recesses, or interlocking undulating surfaces. Additionally, the coupling device 32 engages the distal edges 44 of the fourth wall 42 of the first half 28 and the second wall 38 of the second half 30.

One of the walls, i.e., the first wall 36, the second wall 38, the third wall 40, or the fourth wall 42, of each of the first half 28 and the second half 30, is defined as a support wall 52. As shown, the third wall 40 of each of the first half 28 and the second half 30, is defined as the support wall 52. However, it should be appreciated that the support wall 52 could alternatively be defined by any of the first wall 36, the second wall 38, the third wall 40, or the fourth wall 42. As noted above each of the first wall 36, the second wall 38, the third wall 40, and the fourth wall 42 extend vertically upward from the bottom wall 34, to the distal edge 44. Accordingly, it should be appreciated that the support wall 52 extends from the bottom wall 34 upward to the distal edge 44,

A first reflective triangle 54 is coupled to the support wall 52 of the first half 28 of the storage bin 26. A second reflective triangle 56 is coupled to the support wall 52 of the second half 30 of the storage bin 26. Each of the first reflective triangle 54 and the second reflective triangle 56 is covered with a reflective surface to reflect light. Each of the first reflective triangle 54 and the second reflective triangle 56 is moveable between a stored position adjacent their respective support wall 52, and a deployed position extending vertically upward from their respective support wall 52. Because the first half 28 and the second half 30 of the storage bin 26 may be separated from each other and removed from the vehicle 22, the first reflective triangle 54 and the second reflective triangle 56 may be positioned remotely from the vehicle 22, and remotely from each other, to provide a visual alert to oncoming traffic. The first reflective triangle 54 and the second reflective triangle 56, and their attachment and operation relative to the first half 28 and the second half 30 of the storage bin 26 respectively are identical. Accordingly, while the written description below only refers to the second reflective triangle 56, it should be appreciated that the description is applicable to the first reflective triangle 54 as well.

When positioned in the deployed position, the second reflective triangle 56 is attached to the support wall 52, and is disposed adjacent the distal edge 44 of the support wall 52, i.e., the third wall 40 of the second half 30 of the storage bin 26. The storage bin 26 supports the second reflective triangle 56, and positions the second reflective triangle 56 in an upright vertical position a distance above the bottom wall 34. As such, the second half 30 of the storage bin 26 positions the second reflective triangle 56 a distance above a surface upon which the second half 30 of the storage bin 26 is placed, thereby improving visibility of the second reflective triangle 56.

Preferably, the second reflective triangle 56 is pivotably attached to the support wall 52 to allow movement of the second reflective triangle 56 between the stored position and the deployed position. Additionally, the second reflective triangle 56 may be collapsible for storage in the stored position.

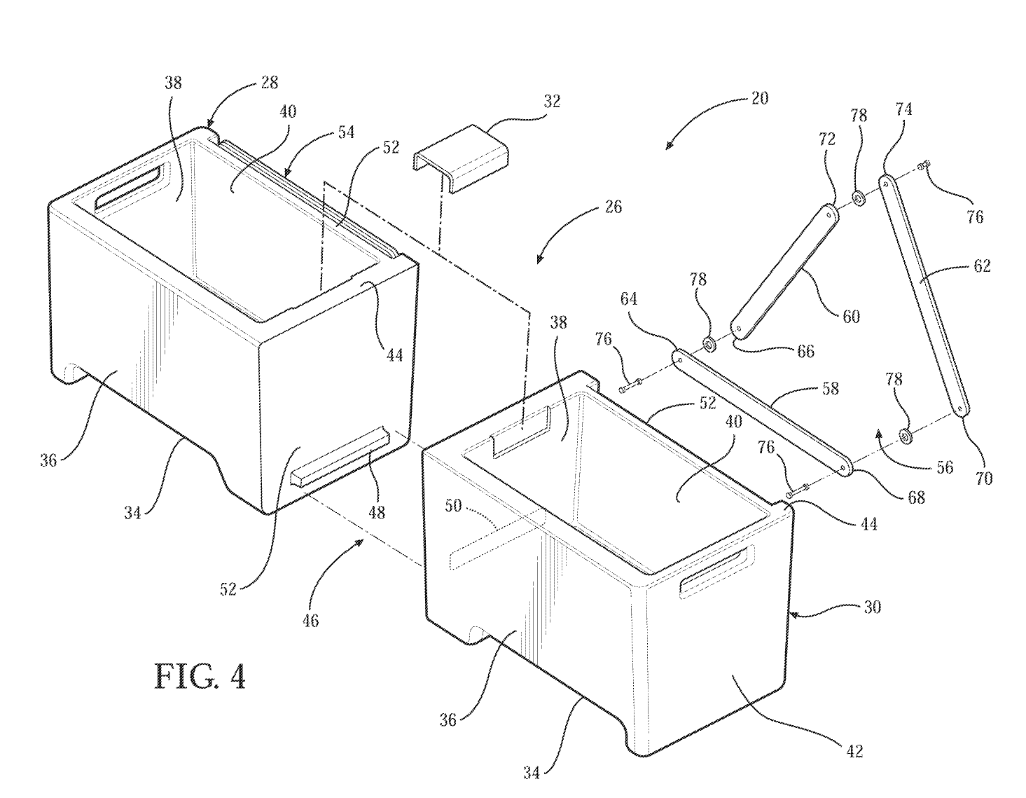

As shown in FIG. 4, the second reflective triangle 56 includes a first portion 58, a second portion 60, and a third portion 62, all pivotably linked together. At least one of the first portion 58, the second portion 60, and the third portion 62 may be pivotably attached to the support wall 52 of the storage bin 26. As shown, the first portion 58 of the second reflective triangle 56 is shown attached to the support wall 52 at each axial end of the first portion 58, and both the second portion 60 and the third portion 62 are pivotably attached to the support wall 52. When configured for storage in the stored position, the first portion 58, the second portion 60, and the third portion 62 fold into a substantially parallel arrangement. The first reflective triangle 54 is shown in the stored position in FIGS. 2 through 4. In order to configure the reflective triangles for operation in the deployed position, the second portion 60 and the third portion 62 are rotated upward, and an end of each of the second portion 60 and the third portion 62 are connected, thereby forming a triangle with the first portion 58.

Referring to FIG. 4, each end of each of the first portion 58, the second portion 60, and the third portion 62 of the second reflective triangle 56, is configured for attachment to an end of one of the other of the first portion 58, the second portion 60, and the third portion 62. As shown in FIG. 4, a first end 64 of the first portion 58 is attached to a second end 66 of the second portion 60. A second end 68 of the first portion 58 is attached to a first end 70 of the third portion 62, and a first end 72 of the second portion 60 is attached to a second end 74 of the third portion 62.

A fastening mechanism 76 connects each connected pair of ends of the first portion 58, the second portion 60, and the third portion 62 of the first reflective triangle 54. As such, each fastening mechanism 76 interconnects one end of one of the first portion 58, the second portion 60, and the third portion 62 with another end of another of the first portion 58, the second portion 60, and the third portion 62, to define a linked connection between a pair of portions. The fastening mechanisms 76 may include, but are not limited to, a rivet, a bolt, a screw, a clip, or some other device capable of coupling the ends of the first portion 58, the second portion 60, and the third portion 62 together.

A gripping device 78 may be disposed between each pair of portions of the linked connections. Accordingly, one gripping device 78 may be disposed between the first end 64 of the first portion 58 and the second end 66 of the second portion 60, a second gripping device 78 may be disposed between the second end 68 of the first portion 58 and the first end 70 of the third portion 62, and a third gripping device 78 may be disposed between the first end 72 of the second portion 60 and the second end 74 of the third portion 62. The gripping devices 78 are operable to prevent relative slippage between the pair of portions of the linked connections. The gripping devices 78 may include, but are not limited to, a rubber washer.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A storage bin for a vehicle, the storage bin comprising:
a bottom wall;
a support wall extending vertically upward from the bottom wall; and
a reflective triangle coupled to the support wall, wherein the reflective triangle is moveable between a stored position adjacent the support wall, and a deployed position extending vertically upward from the support wall;
wherein the storage bin supports the reflective triangle, and positions the reflective triangle in an upright vertical position a distance above the bottom wall when the reflective triangle is disposed in the deployed position.

2. The storage bin as set forth in claim 1 wherein the reflective triangle is collapsible for storage in the stored position.

3. The storage bin as set forth in claim 1 wherein the reflective triangle is pivotably attached to the support wall to allow movement of the reflective triangle between the stored position and the deployed position.

4. The storage bin as set forth in claim 1 wherein the reflective triangle includes a first portion, a second portion, and a third portion, all pivotably linked together.

5. The storage bin as set forth in claim 4 wherein each end of each of the first portion, the second portion, and the third portion is configured for attachment to an end of one of the other of the first portion, the second portion, and the third portion.

6. The storage bin as set forth in claim 4 wherein the first portion, the second portion, and the third portion fold into a substantially parallel arrangement for storage in the stored position.

7. The storage bin as set forth in claim 4 wherein at least one of the first portion, the second portion, and the third portion is pivotably attached to the support wall of the storage bin.

8. The storage bin as set forth in claim 4 further comprising a plurality of fastening mechanisms, with each fastening mechanism interconnecting one end of one of the first portion, the second portion, and the third portion with another end of another of the first portion, the second portion, and the third portion, to define a linked connection between a pair of portions.

9. The storage bin as set forth in claim 8 further comprising a gripping device disposed between each pair of portions of the linked connections, wherein the gripping device is operable to prevent relative slippage between the pair of portions of the linked connections.

10. The storage bin as set forth in claim 9 wherein the gripping device includes a rubber washer.

11. The storage bin as set forth in claim 1 wherein the support wall extends from the bottom wall upward to a distal edge, and wherein the reflective triangle is disposed adjacent the distal edge of the support wall when positioned in the deployed position.

12. The storage bin as set forth in claim 1 wherein the storage bin includes a first half and a second half, and wherein the reflective triangle includes a first reflective triangle attached to the first half of the storage bin, and a second reflective triangle attached to the second half of the storage bin.

13. The storage bin as set forth in claim 12 wherein the first half and the second half of the storage bin are detachably coupled to each other.

14. The storage bin as set forth in claim 13 further comprising a coupling device connecting the first half and the second half of the storage bin together.

15. The storage bin as set forth in claim 14 wherein the first half and the second half of the storage bin each include interlocking retention features for positioning the first half and the second half of the storage bin relative to each other.

16. The storage bin as set forth in claim 14 wherein one of the first half and the second half of the storage bin includes a tongue molded into an end wall thereof, and the other of the first half and the second half of the storage bin defines a groove molded into an end wall thereof, wherein the groove receives the tongue therein in interlocking engagement when positioned adjacent each other.

17. A cargo system for a vehicle, the cargo system comprising:
a storage bin including a first half and a second half detachably coupled to each other, wherein each of the first half and the second half of the storage bin includes a bottom wall and a support wall extending vertically upward from the bottom wall;
a first reflective triangle coupled to the support wall of the first half of the storage bin, and a second reflective triangle coupled to the support wall of the second half of the storage bin, wherein each of the first reflective triangle and the second reflective triangle is moveable between a stored position adjacent their respective support wall, and a deployed position extending vertically upward from their respective support wall; and
a coupling device connecting the first half and the second half of the storage bin together, wherein the coupling device is removable to release the first half from the second half to allow the first reflective triangle and the second reflective triangle to be positioned remotely from each other.

18. The cargo system as set forth in claim 17 wherein the first reflective triangle is pivotably attached to the first half of the storage bin, and the second reflective triangle is pivotably attached to the second half of the storage bin.

19. The cargo system as set forth in claim 17 wherein each of the first reflective triangle and the second reflective triangle is collapsible for storage in the stored position.

20. The cargo system as set forth in claim 17 wherein one of the first half and the second half of the storage bin includes a tongue molded into an end wall thereof, and the other of the first half and the second half of the storage bin defines a groove molded into an end wall thereof, wherein the groove receives the tongue therein in interlocking engagement when positioned adjacent each other to position the first half and the second half relative to each other.
